(19) United States
(12) Patent Application Publication
(10) Pub. No.: US 2026/0220417 A1
(43) Pub. Date: Jul. 30, 2026

(54) SECURITY TAG

(71) Applicant: Sensormatic Electronics, LLC, Boca Raton, FL (US)

(72) Inventors: Katherine Fay GOODMAN, Irvine, CA (US); Tamlyn Jaret Jones, Rancho Mission Viejo, CA (US); Marc H. Blanchenay, Lighthouse Point, FL (US); Olivier Bruno Sommer, Knoxville, TN (US); Lauri Johannes Huhtasalo, Tampere (FI)

(21) Appl. No.: 19/445,245

(22) Filed: Jan. 9, 2026

Related U.S. Application Data
(63) Continuation of application No. 18/350,507, filed on Jul. 11, 2023, now Pat. No. 12,536,401.
(60) Provisional application No. 63/374,138, filed on Aug. 31, 2022.

(51) Int. Cl. G06K 19/077

(52) U.S. Cl. CPC G06K 19/07773

(57) ABSTRACT

A security tag includes: an elongated inlay portion; an antenna mounted on the elongated inlay portion; and a radio frequency identification (RFID) circuit coupled with the antenna. The security tag may be encapsulated within an elongated textile protective sleeve. At least one of the elongated inlay portion, the antenna or the RFID circuit are adapted to dissolve in water.

### CROSS-REFERENCE TO RELATED APPLICATION(S)

This application is a continuation of U.S. patent application Ser. No. 18/350,507, filed Jul. 11, 2023, which claims the benefit of U.S. Provisional Application No. 63/374,138, entitled “WATER SOLUBLE SECURITY TAG” and filed on Aug. 31, 2022, which is expressly incorporated by reference herein in the entirety.

### FIELD

The present disclosure relates generally to security tags, such as a water soluble electronic article surveillance tag, which may be attached to or incorporated into an article, such as a textile or other items, and which may be at least partially dissolved in water during a wash cycle.

### BACKGROUND

Electronic Article Surveillance (EAS) systems are commonly used in retail stores and other settings to prevent the unauthorized removal of goods from a protected area. Typically, a detection system is configured at an exit from the protected area, which comprises one or more transmitters and antennas (“pedestals”) capable of generating an electromagnetic field across the exit, known as the “interrogation zone.” Articles to be protected are tagged with a security tag (such as a radio frequency identification (RFID) and/or an acousto-magnetic (AM) tag), also known as an EAS marker, that, when active, generates a response signal when passed through this interrogation zone. An antenna and receiver in the same or another “pedestal” detect this response signal and generate an alarm.

Additionally, permanent hidden/embedded tags in goods could be used for other purposes, such as, but not limited to, circular economy applications (new business models like renting clothes, or selling second hand clothes with known authenticity and pedigree). In many cases the same tag can be used for multiple purposes: security (anti-theft), circular economy, supply chain management, and/or inventory management.

One drawback of tagging goods with EAS markers and other security tags for purposes of theft prevention is that such tags can affect privacy of consumers. Consumers in many cases may be concerned about being tracked by an EAS marker.

Thus, improvements in efficient removal of security tags are needed.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure provides systems, apparatuses, and methods for providing security tags that are inserted into apparel items. In an aspect, the security tags may be at least partially dissolved in water during a wash cycle of apparel items in order to protect privacy of consumers, for example.

In an aspect, a security tag includes: an elongated inlay portion; an antenna mounted on the elongated inlay portion; and a radio frequency identification (RFID) circuit coupled with the antenna. The security tag may be encapsulated within an elongated textile protective sleeve. At least a portion of the security tag is adapted to dissolve in water. For example, in some aspects, at least one of the elongated inlay portion, the antenna, and/or the RFID circuit are adapted to dissolve in water.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is an illustration of an example architecture for a system according to some present aspects;

FIG. 2 is a partial cut-away isometric view of an example architecture for a tag according to some present aspects;

FIG. 3 is an isometric view of an alternative architecture for a tag according to some present aspects;

FIG. 4 is an exploded perspective view of the architecture of FIG. 2, according to some present aspects; and

FIG. 5 is a perspective view of a security tag having a welded-on sleeve, according to some present aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Aspects of the present disclosure provide a security tag, such as a passive radio frequency identification (RFID) tag, which is designed to be physically capable of withstanding tensile, compressive, and/or abrasive forces which occur while positioning and/or affixing the security tag into an item, yet is sufficiently flexible and/or soft so as to not be noticeable to a person wearing the item. Additionally, in an aspect, the security tag, which may be at least partially water-soluble, is configured to be incorporated into an interface between different layers of an item, such as a garment or article of clothing. Moreover, at least a portion of the security tag can be effectively removed from the item during a wash cycle of the item.

Turning now to the figures, example aspects are depicted with reference to one or more components described herein, where components in dashed lines may be optional.

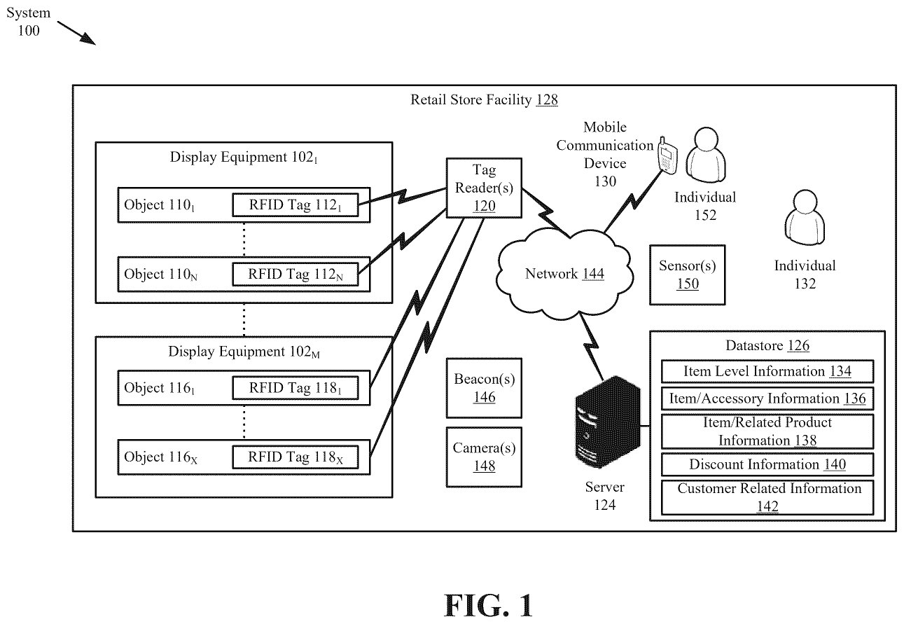

Referring now to FIG. 1, there is provided a schematic illustration of an example system 100 that is useful for understanding the present aspects. The present aspects are described herein in relation to a retail store environment. The present aspects are not limited in this regard and can be used in other environments. For example, the present aspects can be used in distribution centers, factories, and other commercial environments. Notably, the present aspects can be employed in any environment in which objects and/or items need to be located and/or tracked.

The system 100 is generally configured to allow: (a) improved inventory counts and surveillance of objects and/or items located within a facility, and/or (b) improved customer experiences. As shown in FIG. 1, system 100 comprises a Retail Store Facility (“RSF”) 128 in which display equipment 102₁-102_{M} are disposed. The display equipment are provided for displaying objects (or items) 110₁-110_{N}, 116₁-116_{X} to customers of the RSF 128. The display equipment may include, but are not limited to, shelves, article display cabinets, promotional displays, fixtures, and/or equipment securing areas of the RSF 128. The RSF 128 can also include emergency equipment (not shown), checkout counters, video cameras, people counters, and conventional electronic article surveillance (EAS) systems well known in the art, and therefore will not be described herein.

At least one tag reader 120 is provided to assist in counting and tracking locations of the objects 110₁-110_{N}, 116₁-116_{X} within the RSF 128, and/or to perform a checkout process associated with a user purchasing a respective object. The tag reader 120 may comprise an RFID reader configured to read RFID tags. Such a tag read may include the tag reader 120 receiving an identifier (e.g., a unique identifier) of a respective RFID tag 112, which may be associated with an identifier of the object 110 to which the RFID tag 112 is attached.

RFID tags 112₁-112_{N}, 118₁-118_{X} are respectively attached to the objects 110₁-110_{N}, 116₁-116_{X} as described below. This attachment may be achieved by a structural configuration of the RFID tag to enable the attachment. The RFID tags 112₁-112_{N}, 118₁-118_{X} can alternatively or additionally comprise dual-technology tags that have both EAS and RFID capabilities as described herein. In examples of the technology disclosed herein, the RFID tag is sewn or otherwise affixed into an object 110, for example into an interface between layers of the fabric/cloth of the object 110, which may be clothing or which may be another retail item.

Notably, the tag reader 120 may be placed at a known location within the RSF 128, for example, at an exit/entrance. By correlating the RFID tag reads of the tag reader 120 and the known location of the tag reader 120 within the RSF 128, the general location of objects 110₁, . . . 110_{N}, 116₁, . . . 116_{X} may be determined within the RSF 128. The known coverage area of the tag reader 120 also facilitates object location determinations. Accordingly, RFID tag read information and tag reader location information is stored in a datastore 126. This information may be stored in the datastore 126 using a server 124 and a network 144 (e.g., an Intranet and/or Internet). Additionally, the tag reader 120 or another computer device, such as but not limited to a point of sale terminal, may read a respective RFID tag 112 during a check-out or payment process and confirm that the object 110 to which the RFID tag 112 is attached is the object being paid for in the check-out or point of sale transaction.

System 100 may also comprise a Mobile Communication Device (“MCD”) 130. MCD 130 includes, but is not limited to, a cell phone, a smart phone, a table computer, a personal digital assistant, and/or a wearable device (e.g., a smart watch). In accordance with some examples, the MCD 130 has a software application installed thereon that is operative to facilitate the provision of various information (e.g., 134, 136, 138, 140, and/or 142) to the individual 152 and/or to facilitate the sale or purchase transaction.

The MCD 130 may generally be configured to provide a visual and/or auditory output of item level information 134, accessory information 136, related product information 138, discount information 140, and/or customer related information 142.

The MCD 130 may also be configured to read barcodes and/or the RFID tag 112. Information obtained from the barcode and/or RFID tag reads may be communicated from the MCD 130 to the server 124 via network 144. Similarly, the stored information (e.g., 134, 136, 138, 140, and/or 142) may be provided from the server 124 to the MCD 130 via the network 144. The network 144 may include an Intranet and/or the Internet.

Server 124 may be local to the RSF 128 as shown in FIG. 1 or remote from the RSF 128. It should be understood that server 124 may be configured to: write data to and read data from datastore 126, RFID tags 112₁-112_{N}, 118₁-118_{X}, and/or MCD 130; perform language and currency conversion operations using item level information 134 and/or accessory information 136 obtained from the datastore 126, RFID tags 112₁-112_{N}, 118₁-118_{X}, and/or MCD 130; perform data analytics based on inventory information (e.g., 134, 136, 138, 140, and/or 142), tag read information, MCD tacking information, and/or information 134-142; perform image processing using images captured by camera(s) 148; and/or determine locations of RFID tags 112₁-112_{N}, 118₁-118_{X} and/or MCDs 130 in the RSF 128 using beacon(s) 146, tag reader 120, or other devices having known locations and/or antenna patterns.

In some examples, one or more beacons 146 transmitting a radio frequency (RF) signal (e.g., a second RF signal) other than the RFID interrogation signal are placed to cover a zone of interest (which in some cases may be also covered by a tag reader 120 placed to cover an RFID interrogation zone), e.g., at a portal (such as an entrance or exit) of the RSF 128.

The server 124 may update the information (e.g., 134, 136, 138, 140, and/or 142) output from the MCD 130 and/or the tag reader 120 and/or any other terminal and/or point of sale device that interacts with the RFID tag 112. Such information updating may be performed in response to instructions received from an associate (e.g., a retail store employee 132), in response to a detected change in the item level information 134, accessory information 136, and/or related product information 138, in response to a detection that an individual is in proximity to an RFID tag, and/or in response to any motion or movement of the RFID tag. For example, if a certain product is placed on sale, then the sale price for that product may be transmitted to MCD 130 via network 144 and/or RFID tag 112/118. The sale price may then be output from the MCD 130. It should be noted that the present aspects are not limited to the particulars of this example.

Although a single MCD 130 and/or a single server 124 is (are) shown in FIG. 1, the present aspects are not limited in this regard. More than one computing device may be implemented. In addition, the present aspects are not limited to the example system architecture described in relation to FIG. 1.

In some aspects, during operation of system 100, the content displayed on the display screen of the MCD 130 may be dynamically controlled based upon various tag or item related information and/or customer related information (e.g., mobile device identifier, mobile device location in RSF 128, and/or customer loyalty level). Tag or item level information 134 may include, but is not limited to, one or more of first information indicating that an RFID tag 112/118 is in motion or that an object is being handled by an individual 152, second information indicating a current location of the RFID tag 112/118 and/or the MCD 130, third information indicating an accessory or related product of the object to which the moving RFID tag is coupled, and/or fourth information indicating the relative locations of the accessory and the moving RFID tag 112/118 and/or the relative locations of the related product and the moving RFID tag 112/118. The first, second, and fourth information may be derived based on sensor data generated by one or more sensors 150 local to the RFID tag. In other words, in some cases, the RFID tags 112₁-112_{N}, 118₁-118_{X} may include one or more sensors 150 to detect their current locations, detect any individual in proximity thereto, and/or detect any motion or movement thereof. The sensors 150 may include, but are not limited to, an Inertial Measurement Unit (“IMU”), a vibration sensor, a light sensor, an accelerometer, a gyroscope, a proximity sensor, a microphone, and/or a beacon communication device. The third information may be stored local to the RFID tag(s) or in a remote datastore 126 as information 136, 138.

In those or other scenarios, a sensor embedded in the RFID tag 112/118 may detect when an individual 152 is handling the object in which the RFID tag 112/118 is inserted. When such a detection is made, the RFID tag 112/118 may retrieve the object's unique identifier from its local memory, and wirelessly communicates the same to the tag reader 120. The tag reader 120 may then pass the information to the server 124. The server 124 may use the object's unique identifier and the item/accessory relationship information (e.g., table) 136 to determine if there are any accessories associated therewith. If no accessories exist for the object, the server 124 may use the item level information 134 to determine one or more characteristics of the object. For example, the object may comprise a product of a specific brand. The server 124 may then use the item/related product information (e.g., table) 138 to identify: other products of the same type with the same characteristics; and/or other products that are typically used in conjunction with the object. Related product information for the identified related products may then be retrieved and provided to the MCD 130. The MCD 130 may output the related product information in a visual format and/or an auditory format. The individual 152 may perform user-software interactions with the MCD 130 to obtain further information related to the product of interest. The present solution is not limited to the particulars of this scenario.

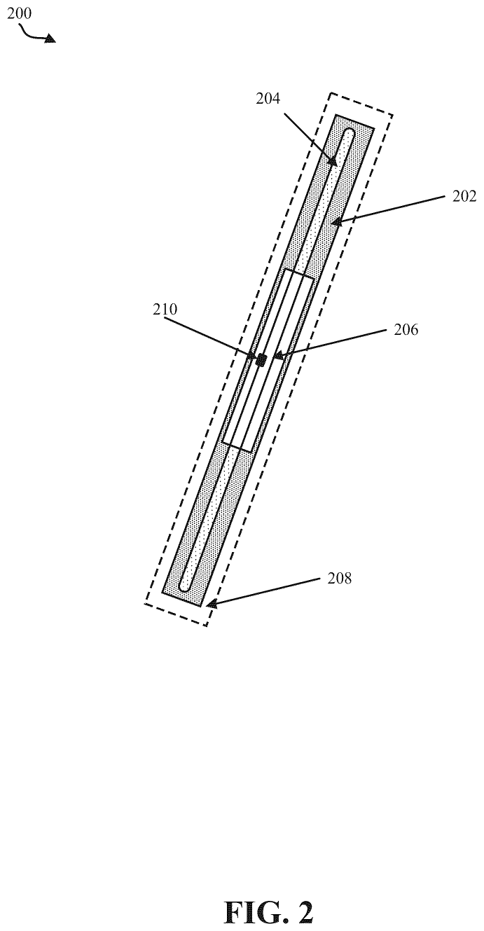

Referring to FIGS. 2-5, an example architecture for a security tag 200 is shown. RFID tags 112₁-112_{N}, 118₁-118_{X} are the same as or similar to security tag 200. As such, the discussion of security tag 200 is sufficient for understanding the RFID tags 112₁-112_{N}, 118₁-118_{X} of FIG. 1. In some implementations, security tag 200 may be configured to perform operations such as but not limited to: (a) minimize power usage so as to extend a power source's life (e.g., a battery or a capacitor), (b) minimize collisions with other tags so that the tag of interest can be seen at given times, and/or (c) optimize useful information within an inventory system (e.g., communicate useful change information to a tag reader) Notably, the security tag 200 may be designed to be relatively thin and relatively flexible so that it is hard to feel when inserted into an item (e.g., object 110₁, . . . , 110_{N}, 116₁, . . . , or 116_{X} of FIG. 1). The object may include, but is not limited to, an article of clothing. In an aspect, at least one component of the security tag 200 may be water soluble.

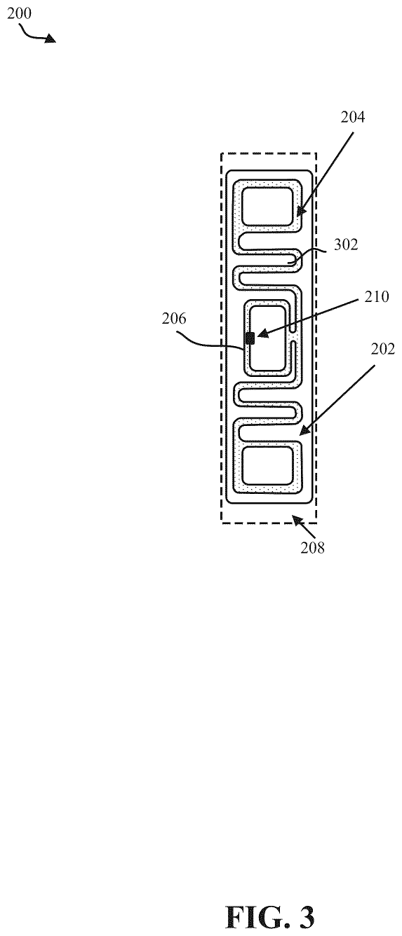

Security tag 200 may include, for example, a semiconductor integrated circuit 210, e.g., an RFID chip, which provides the RFID-based functionality described above, electrically connected to a tunable antenna 204 that enables the circuit 210 to receive and/or transmit signals, and may be mounted on an inlay 202. The tunable antenna 204 may include a loop portion 206 as shown in FIGS. 2 and 3. The tunable antenna 204 may be tuned to a desired operating frequency by adjusting the length of the tunable antenna 204. The range of operating frequencies may vary. In one embodiment, for example, the tunable antenna 204 may be tuned to operate within an RFID operating frequency.

The inlay 202 to which the semiconductor integrated circuit 210 and the tunable antenna 204 are attached may be a relatively thin, narrow, light-weight, and water soluble substrate. In one aspect, the inlay 202 may be an elongated inlay 202 having a length substantially equal to or slightly greater than a length of the tunable antenna 204. In other words, the longitudinal length of the elongated inlay 202 and the longitudinal length of the tunable antenna 204 may be substantially equal.

The inlay 202 may include, but is not limited to, any type of water soluble material (e.g., a cold water soluble material), non woven material or film material. In some embodiments, the water soluble material may be a fabric material or a film material, and such fabric material may be nonwoven. In an embodiment, the fabric material may be a cold water soluble nonwoven material manufactured from partially hydrolyzed polyvinyl alcohol fibers (a PVA fabric). In an embodiment, the PVA fabric may substantially retain water until the water soluble material of the inlay 202 disintegrates during a wash cycle. In an aspect, the biodegradable material may be a biodegradable paper material or another hydrophilic material. A thickness of the inlay 202 may be selected so that the inlay 202 has a physical strength that allows a threshold amount of tension and/or compression to be maintained on the security tag 200 while attaching the tag to an object 110/116. For example, but not limited hereto, the thickness can have a value between approximately 10 um and approximately 200 um. Further, for example but not limited hereto, a width of the inlay 202 may be between approximately 2.5 mm and approximately 5 mm, which is small enough so that the security tag 200 is not felt by humans when inserted into an object. It should be understood that the present solution is not limited to the particulars of this example.

In some aspects, the inlay 202 may comprise a polyester (e.g., PET) substrate.

In some aspects, at least a portion of the tunable antenna 204 of the security tag 200 may be formed as conductive trace(s) 302 (see FIG. 3) via etching. The conductive trace/layer may be, but is not limited to, aluminum. In this case, only the inductive loop portion 206 of the tunable antenna 204 may be formed from a water soluble material. Advantageously, this implementation enables to produce the largest part of the security tag 200 (the conductive traces 302 of the tunable antenna 204) with conventional methods and materials.

Generally speaking, the resonance characteristics and tuning (and tunability) of the tunable antenna 204 may be determined not only by the antenna geometric shape and dimensions, material layering and construction, and fabrication materials, but also by the characteristics of the environment surrounding the antenna. Types of antennas that may be used in the security tag 200 may include dipole antennas, patch antennas, slot antennas, and many other types and variations of these types. The tunable antenna 204 may be designed so that the operating frequency of the security tag 200 is an ultra high frequency (UHF).

The tunable antenna 204 may be configured to electrically couple with the circuit 210, such as via inductance. The tunable antenna 204 may longitudinally extend across substantially the entire length of the security tag 200. The tunable antenna 204 may be fabricated by positioning a water-soluble conducting ink on the inlay 202. Materials used for the conductive ink may include, but are not limited to, a metal particle, including but not limited to, silver, copper, graphene, a flux, a dispersing agent, an inorganic binder, a metal oxide, an organic metal compound, or a mixture of two or more thereof. However, in various implementations, the tunable antenna 204 may be made of conductive wire, like copper wire, steel wire, and the like.

In some aspects, but not limited hereto, the tunable antenna 204 may extend along the security tag 200 in a longitudinal direction and may have a diameter around 100 microns.

Additionally, the security tag 200 may further include an elongated protective sleeve 208 which substantially encapsulates the inlay 202, the tunable antenna 204, the loop portion 206, and the circuit 210. The protective sleeve 208 may be formed of a fabric or a plastic material, and may be a single sheet wrapped around the internal components and sealed or fixed together on one side, or two opposing sheets sealed or fixed together on each side.

In the present aspects, the security tag 200 may be flexible, bendable, stretchable, or otherwise configured and/or constructed to sustain deformations. Further, for example but not limited hereto, a width of the security tag 200 may be between 3.5 mm and 6 mm, and a length of the security tag 200 may be between 80 mm and 145 mm which is small enough so that the tag is not felt by humans when inserted into an item. The present aspects are not limited to the particulars of this example. Also, the flexibility of the security tag 200 allows for the security tag 200 to be constructed and arranged so that the aforementioned deformations do not negatively affect the functionality and operation of the electronic components disposed within the security tag 200. In some aspects, electronic components are positioned on one side off a center of the security tag 200, so that a stitching lane may be created for secure attachment of the security tag 200 to an article of clothing. In some aspects, the security tag 200 may be manufactured to satisfy standards of environmental sustainability. For example, in some aspects, a natural-fiber fabric, recycled materials, or bio-based materials may be used as the inlay 202 (or as a portion of the inlay 202) so that the security tag 200 incorporates less plastic material than conventional security tags. Recycled materials may include, but are not limited to, recycled polyester or recycled paper, and bio-materials may include, but are not limited to, biopolymers or paper.

Referring more specifically to FIG. 3, an example of an alternative architecture for the security tag 200 is provided. In this example architecture, the integrated circuit 210 and the loop portion 206 may be incorporated into the design of the tunable antenna 204. In an aspect, the tunable antenna 204 may include a rectangular loop antenna, which is inherently differential.

The inlay 202 material may include, but is not limited to, standard paper or water dissolvable paper. It should be noted that portions of the paper which are not completely dissolved during a wash cycle may remain inside the protective sleeve 208 In summary, the security tag 200 may be produced by combining different material and/or component layers, such as the tunable antenna 204 attached to the inlay 202, the intermediate layer including a semiconductor integrated circuit 210 electrically coupled with a loop portion 206, such as via inductive coupling, and the outer layer including an elongated protective sleeve 208, such as formed from a fabric, that covers the semiconductor integrated circuit 210, the tunable antenna 204, and the inlay 202. The protective sleeve 208 may comprise an ultrasonically weldable thermoplastic material, such as, but not limited to, nylon, combination of polyester and cotton, and the like. Advantageously, the tunable antenna 204 is designed to be very narrow as compared to typical RFID antennas. Although the protective sleeve 208 in this example is illustrated as a top layer, it should be understood that the outer layer may alternatively or additionally include a bottom layer. In one implementation, the elongated protective sleeve 208 includes a single textile sheet having a first longitudinal side fixedly attached to an opposite, second longitudinal side.

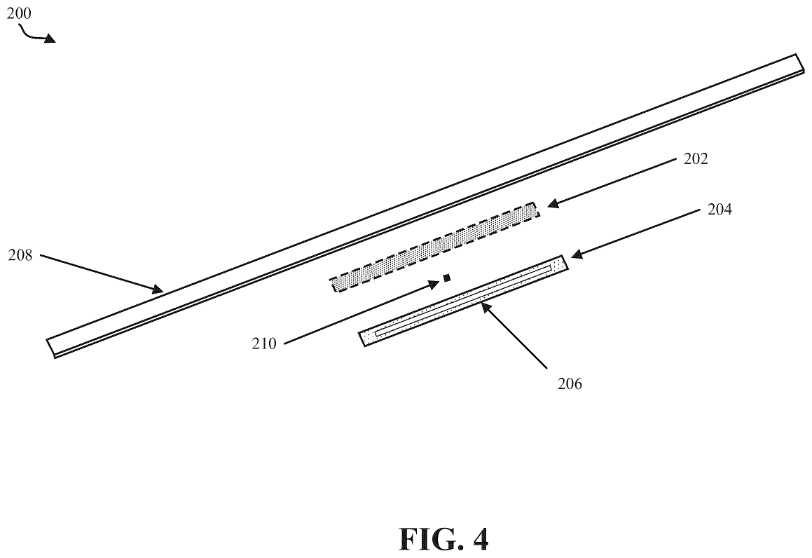

FIG. 4 is an exploded perspective view of the architecture of FIG. 2, according to some present aspects

It should be understood, however, that the various layers may be manufactured and/or assembled in a different manner and/or in a different order and/or by different entities (e.g., antenna manufacturer, tag manufacturer, tag converter entities).

Thus, the methods and structures herein provide a flexible, fabric-like, narrow security tag 200 that can be easily and efficiently attached (sewn) into a space between seams that connect two adjacent layers of material of an article of clothing. The two layers of the article of clothing may be stitched together by overlock stitches. However, in various aspects, the security tag 200 may be sewn, glued, or welded onto any other portion of an article of clothing.

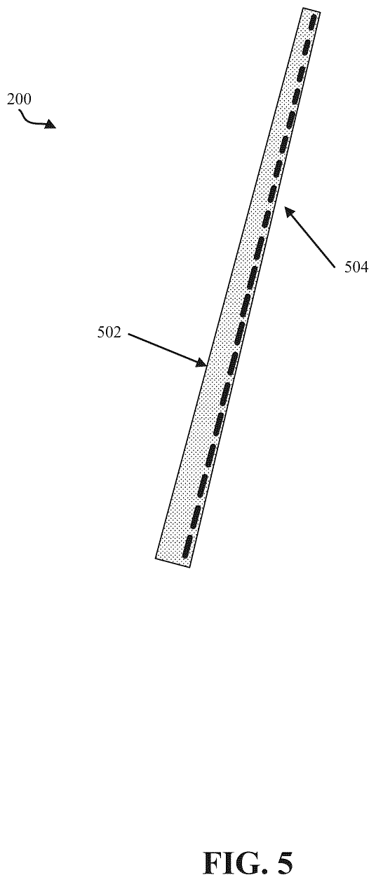

Referring to FIG. 5, a completed welded security tag, such a security tag 200 includes the electronic components being positioned on one side 502 off a center of the security tag 200, so that a continuous stitching lane 504 may be created for secure attachment of the security tag 200 to an article of clothing. In other words, since the electronic components are situated on one side of the security tag 200, they are less likely to be damaged by sewing needles when the security tag 200 is attached to an article of clothing.

The disclosed aspects provide a soft, easy to attach, discreet, high-performing, durable, and economical RFID security tag having one or more water soluble components. In an aspect, such a tag can be attached to an overlock seam of the article. For example, some disclosed aspects replace a majority of a PET inlay with a water soluble inlay having a conductive ink antenna in the core of a fabric sleeve. Advantageously, the disclosed aspects enable tagging of thin, lightweight, one-ply garments, which are difficult to tag with any existing tagging solutions. As yet another advantage, the disclosed tag can be easily disabled during a first wash cycle of the garment.

In other words, one aspect of the security tag includes: an elongated inlay portion; an antenna mounted on the elongated inlay portion; and a radio frequency identifier (RFID) circuit coupled with the antenna. The security tag may be encapsulated within an elongated textile protective sleeve. At least one of the elongated inlay portion, the antenna, or the RFID circuit are adapted to dissolve in water.

In one or any combination of these aspects, the antenna is configured to operate at ultra high frequency (UHF).

In one or any combination of these aspects, the elongated inlay portion includes at least one of: a biodegradable material and a water soluble material.

In one or any combination of these aspects, the water soluble material includes at least one of: a nonwoven material and a film material.

In one or any combination of these aspects, the textile protective sleep includes a non-soluble material.

In one or any combination of these aspects, the antenna is attached to an induction loop and the antenna extends along the security tag in a longitudinal direction, wherein the antenna includes a water soluble material and wherein the induction loop includes a non-soluble material.

In one or any combination of these aspects, the antenna is mounted using a water soluble conductive ink.

In one or any combination of these aspects, the elongated textile protective sleeve includes a single textile sheet having a first longitudinal side fixedly attached to an opposite, second longitudinal side.

In one or any combination of these aspects, the elongated textile protective sleeve includes a single textile sheet having a first longitudinal sides fixedly attached to an opposite, second longitudinal side on a first longitudinal tag side off a center of the security tag, and wherein the antenna and the RFID circuit are positioned on a second longitudinal tag side opposite the first longitudinal tag side.

In one or any combination of these aspects, the security tag is configured to be positioned into an interface space between two layers of an article of clothing.

In one or any combination of these aspects, the security tag is configured to be positioned on top of an overlock seam of an article of clothing.

Another aspect of a security tag include: an elongated inlay portion; an antenna mounted on the elongated inlay portion; and a radio frequency identifier (RFID) circuit coupled with the antenna, wherein at least a portion of the security tag is adapted to dissolve in water.

In one or any combination of these aspects, the portion comprises the elongated inlay portion.

In one or any combination of these aspects, the portion comprises the antenna.

In one or any combination of these aspects, the portion comprises the RFID circuit.

In one or any combination of these aspects, the portion comprises at least one of: a biodegradable material and a water soluble material.

In one or any combination of these aspects, the water soluble material comprises at least one of: a nonwoven material and a film material.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A security tag, comprising:
an elongated inlay portion;
an antenna mounted on the elongated inlay portion;
a radio frequency identification (RFID) circuit coupled with the antenna; and
an elongated sleeve formed of a fabric material, the elongated sleeve movably containing the elongated inlay portion, the antenna, and the RFID circuit.

2. The security tag of claim 1, wherein the antenna is configured to operate at ultra high frequency (UHF).

3. The security tag of claim 1, wherein the elongated inlay portion comprises at least one of: a biodegradable material and a water soluble material.

4. The security tag of claim 3, wherein the water soluble material comprises at least one of: a nonwoven material and a film material.

5. The security tag of claim 1, wherein the antenna is coupled with an induction loop and the antenna extends along the security tag in a longitudinal direction.

6. The security tag of claim 5, wherein the induction loop comprises a non-soluble material.

7. The security tag of claim 1, wherein the antenna further comprises an inductive loop electrically coupled with the RFID circuit.

8. The security tag of claim 1, wherein the elongated sleeve comprises:
a first textile material layer; and
a second textile material layer;
wherein the first textile material layer is fixedly attached to the second textile material layer on at least one longitudinal side.

9. The security tag of claim 1, wherein the elongated sleeve comprises a non-soluble material.

10. The security tag of claim 1, wherein the elongated sleeve comprises a single textile sheet having a first longitudinal side fixedly attached to an opposite, second longitudinal side.

11. The security tag of claim 1, wherein the elongated sleeve comprises a single textile sheet having a first longitudinal side fixedly coupled with an opposite, second longitudinal side on a first longitudinal tag side

12. The security tag of claim 11, wherein the antenna and the RFID circuit are positioned adjacent to a second longitudinal tag side opposite the first longitudinal tag side.

13. The security tag of claim 1, wherein the security tag is configured to be positioned into an interface between two layers of an article of clothing.

14. The security tag of claim 1, wherein the security tag is configured to be positioned on top of an overlock seam of an article of clothing.

15. A security tag, comprising:
an elongated inlay portion;
an antenna mounted on the elongated inlay portion; and
a radio frequency identification (RFID) circuit coupled with the antenna; and
an elongated protective sleeve formed of a fabric material, the elongated protective sleeve movably holding the elongated inlay portion, the antenna, and the RFID circuit, the fabric material comprising:
a first textile material layer; and
a second textile material layer;
wherein the first textile material layer is fixedly attached to the second textile material layer on at least one longitudinal side; and
wherein the security tag is configured to be positioned into an interface between two layers of an article of clothing or on top of an overlock seam of the article of clothing.

16. The security tag of claim 15, wherein the the elongated inlay portion comprises a polyester substrate.

17. The security tag of claim 15, wherein the the antenna is configured to operate at ultra high frequency (UHF).

18. The security tag of claim 15, wherein the elongated protective sleeve includes a non-soluble material.

19. The security tag of claim 15, wherein the elongated protective sleeve comprises a single textile sheet having a first longitudinal side fixedly attached to an opposite, second longitudinal side.

20. The security tag of claim 15, wherein the elongated protective sleeve comprises an ultrasonically weldable thermoplastic material.
